(19) United States
(12) Patent Application Publication
(10) Pub. No.: US 2016/0028549 A1
(43) Pub. Date: Jan. 28, 2016

(54) INFORMATION PROCESSING SYSTEM AND ELECTRONIC DEVICE

(71) Applicant: Yasuaki YUJI, Kanagawa (JP)

(72) Inventor: Yasuaki YUJI, Kanagawa (JP)

(21) Appl. No.: 14/803,708

(22) Filed: Jul. 20, 2015

(30) Foreign Application Priority Data
Jul. 24, 2014 (JP) 2014-150896

(51) Int. Cl. H04L 9/32; G06F 21/31; H04L 9/08; H04L 29/06

(52) U.S. Cl. CPC H04L 9/3247; H04L 63/08; G06F 21/31; H04L 9/0861; H04L 63/123

(57) ABSTRACT

An electronic device includes a storage unit configured to store platform information regarding a platform of the electronic device and an expectation value used for verifying an integrity of the platform; a measuring unit configured to measure a measurement value of the integrity of the platform from the platform information; an integrity verifying unit configured to compare the measurement value and the expectation value to verify the integrity of the platform depending on whether the measurement value is equal to the expectation value; an information generator configured to generate integrity information indicating a verification result indicating that the integrity of the platform is impaired when the measurement value is not equal to the expectation value; a signature unit configured to add signature information of the integrity information to the integrity information; and a communication processor configured to transmit the integrity information having the signature information to a management device.

### CROSS-REFERENCE TO RELATED APPLICATION

The present application claims priority to and incorporates by reference the entire contents of Japanese Patent Application No. 2014-150896 filed in Japan on Jul. 24, 2014.

### BACKGROUND OF THE INVENTION

1. Field of the Invention

The present invention relates to an information processing system and an electronic device.

2. Description of the Related Art

In recent years, an advanced security has been required in a field of an embedded device in which significant electronic information is implemented. For a safe usage of a device, it is necessary that a user is able to check and administer integrity information in which integrity of a platform is judged. Especially when a given platform loses the integrity, it is preferable for the user to accurately grasp the loss and not to use information released from the platform. The “loss of integrity” means that a BIOS (Basic Input/Output System), an OS (Operating System), and software data are illegally rewritten, for example.

Here, considered is a situation where a reliable management server (management device) which is present on a network, instead of a user, checks and administers integrity information of the platform. For a method of judging the integrity of the platform, the platform of the device first notifies the management server of a measurement value obtained by measuring the integrity of itself. The management server then compares the measurement value received from the device with a value expected for the measurement of the platform of the device (expectation value) retained in advance. When the measurement value is not equal to the expectation value, it is determined that the integrity of the platform is impaired.

However, it is necessary that, in such a method that a device transmits its own measurement value of the platform to the management server and the management then verifies the integrity of the platform as explained above, the management server needs to be provided with an integrity verifying unit for every platform of all the devices each as a management target. There has therefore been a problem of causing an increase in the size of programs that the management server should retain and in the size of a ROM (Read Only Memory) as the kinds of platforms increase, and thereby causing an increase in a management cost in the management server.

In response to the problem, disclosed in Japanese Laid-open Patent Publication No. 2003-76585, for example, is a device in which a reliable environment agent for judging integrity of a platform is present and integrity information of the platform judged by the environment agent is presented to the user.

However, there has been a problem that a fault result should be transmitted by an ill-intentioned third party or a transmission content should be falsified unless the reliability of a communication path is secured in the case of transmitting the integrity information of the platform judged by the environment agent to the management server on the network like the device disclosed in Japanese Laid-open Patent Publication No. 2003-76585.

Therefore, there is a need for an information processing system and an electronic device capable of reducing a management cost while securing a reliability of a communication path along which integrity information of a platform of an electronic device is transmitted.

### SUMMARY OF THE INVENTION

It is an object of the present invention to at least partially solve the problems in the conventional technology.

According to an embodiment, there is provided an information processing system includes a management device and an electronic device connected to the management device via a network. The electronic device includes a first storage unit configured to store platform information regarding a platform of the electronic device and an expectation value that is preset and used for verifying an integrity of the platform; a measuring unit configured to measure a measurement value of the integrity of the platform from the platform information stored in the first storage unit; an integrity verifying unit configured to compare the measurement value and the expectation value stored in the first storage unit to verify the integrity of the platform depending on whether or not the measurement value is equal to the expectation value; an information generating unit configured to generate integrity information indicating a verification result to an effect that the integrity of the platform is impaired when the measurement value is not equal to the expectation value; a signature unit configured to add signature information of the integrity information to the generated integrity information; and a communication processor configured to transmit the integrity information having the signature information to the management device. The management device includes a second storage unit configured to store the integrity information; a receiver configured to receive the integrity information from the electronic device; and a signature verifying unit configured to verify a validity of the integrity information based on the signature information that is added to the received integrity information and store the received integrity information in the second storage unit when the integrity information is valid.

According to another embodiment, there is provided an information processing system includes a management device, a verification device connected to the management device via a network, and an electronic device connected to the verification device via the network. The electronic device includes a first storage unit configured to store platform information regarding a platform of the electronic device; a measuring unit configured to measure a measurement value of an integrity of the platform from the platform information stored in the first storage unit; a first signature unit configured to add first signature information for the measurement value to the measurement value; and a first communication processor configured to transmit the measurement value having the first signature information to the verification device. The verification device includes a second storage unit configured to store an expectation value that is preset and used for verifying the integrity of the platform of the electronic device; a second communication processor configured to receive the measurement value from the electronic device; a first signature verifying unit configured to verify a validity of the measurement value based on the first signature information that is added to the received measurement value; an integrity verifying unit configured to compare the received measurement value and the expectation value stored in the second storage unit to verify the integrity of the platform depending on whether or not the measurement value is equal to the expectation value when the measurement value is verified to be valid; an information generator configured to generate integrity information indicating a verification result indicating that the integrity of the platform is impaired when the measurement value is not equal to the expectation value; and a second signature unit configured to add second signature information of the integrity information to the generated integrity information. The second communication processor transmits the integrity information having the second signature information to the management device. The management device includes a third storage unit configured to store the integrity information; a receiver configured to receive the integrity information from the verification device; and a second signature verifying unit configured to verify a validity of the integrity information based on the second signature information that is added to the received integrity information, and store the received integrity information in the third storage unit when the integrity information is valid.

According to still another embodiment, there is provided an electronic device connected to a management device via a network. The electronic device includes a storage unit configured to store platform information regarding a platform of the electronic device and an expectation value that is preset and used for verifying an integrity of the platform; a measuring unit configured to measure a measurement value of the integrity of the platform from the platform information stored in the storage unit; an integrity verifying unit configured to compare the measurement value and the expectation value stored in the storage unit to verify the integrity of the platform depending on whether or not the measurement value is equal to the expectation value; an information generator configured to generate integrity information indicating a verification result indicating that the integrity of the platform is impaired when the measurement value is not equal to the expectation value; a signature unit configured to add signature information of the integrity information to the generated integrity information; and a communication processor configured to transmit the integrity information having the signature information to the management device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 illustrates an entire configuration of an information processing system according to a first embodiment;

FIG. 2 illustrates a hardware configuration of a platform according to the first embodiment;

FIG. 3 illustrates a software configuration of an integrity check module according to the first embodiment;

FIG. 4 is an explanatory view of a data structure of notice information according to the first embodiment;

FIG. 5 illustrates a software configuration of a management server according to the first embodiment;

FIG. 6 is a flowchart of an integrity verification processing of a platform in the integrity check module according to the first embodiment;

FIG. 7 is a flowchart of a digital signature processing in the integrity check module according to the first embodiment;

FIG. 8 is a flowchart of a communication processing in the integrity check module according to the first embodiment;

FIG. 9 illustrates a hardware configuration of a platform according to a second embodiment;

FIG. 10 illustrates a software configuration of an integrity check module according to the second embodiment;

FIG. 11 is an explanatory view of a data structure of update information according to the second embodiment;

FIG. 12 is a flowchart of a firmware update processing in the integrity check module according to the second embodiment;

FIG. 13 is a flowchart of a key update processing in the integrity check module according to the second embodiment;

FIG. 14 illustrates an entire configuration of an information processing system according to a third embodiment;

FIG. 15 illustrates a software configuration of an integrity check module according to the third embodiment;

FIG. 16 illustrates a software configuration of a verification server according to the third embodiment;

FIG. 17 illustrates a flow of an integrity verification processing of a platform of an electronic device in the information processing system according to the third embodiment;

FIG. 18 is a flowchart of an integrity verification processing of a platform in the information processing system according to the third embodiment;

FIG. 19 illustrates an entire configuration of an information processing system according to a modification of the first embodiment; and

FIG. 20 illustrates an entire configuration of an information processing system according to a modification of the third embodiment.

### DETAILED DESCRIPTION OF THE PREFERRED EMBODIMENTS

Exemplary embodiments of an information processing system and an electronic device will be explained in detail below with reference to the accompanying drawings.

### First Embodiment

In an information processing system according to an embodiment, an integrity of a platform of an electronic device is configured to be verified in the electronic device and integrity information indicating a result of the verification is configured to be transmitted to a management device (management server).

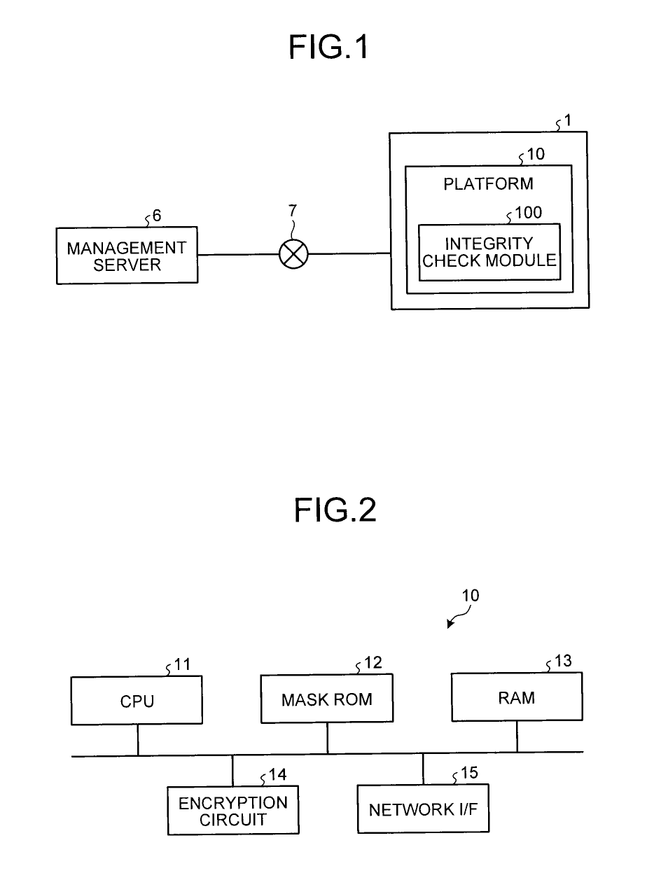

FIG. 1 illustrates an entire configuration of an information processing system according to a first embodiment. As illustrated in FIG. 1, an information processing system according to the embodiment is configured by an electronic device 1 and a management server (management device) 6. The electronic device 1 and the management server 6 are connected by a network 7 such as a wireless network and the Internet. An integrity check module 100 is provided in a platform 10 of the electronic device 1 and the platform 10 and the integrity check module are configured as one chip.

Next, a hardware configuration of the platform 10 will be explained. FIG. 2 illustrates a hardware configuration of the platform 10 according to the first embodiment. As illustrated in FIG. 2, the platform 10 is mainly provided with a CPU (Central Processing Unit) 11, a mask ROM 12, an RAM (Random Access memory) 13, an encryption circuit 14, and a network I/F 15.

The CPU 11, which is a computing device, executes programs stored in the mask ROM 12 and the like.

The mask ROM 12, which is a memory in which various kinds of programs are stored, is a non-volatile storage medium. Specifically, firmware information of the platform 10 of the electronic device 1 (platform information) and an integrity verification program to be executed in the integrity check module 100 are stored in the mask ROM 12. Besides, a digital signature execution program to add a digital signature and a program enabling a communication with an external device are stored in the mask ROM 12.

Moreover, an expectation value, which is a value used for verifying the integrity of the platform 10 and a preset measurement value expected for the measurement, is stored in the mask ROM 12. A private key (first key information), which is key information used for digital signature and with which signature data (signature information) is generated by encrypting integrity information and a public key (second key information), which corresponds to the private key and with which the encrypted signature data is decrypted, are stored in the mask ROM 12. Communication setting information which is set in performing a communication is also stored in the mask ROM 12. Besides, a hash function used in the verification of the integrity of the platform 10 and in generating the signature data is stored in the mask ROM 12. The mask ROM 12 may be referred to as a first storage unit.

The RAM 13, which is a memory in which various kinds of programs and variables during the execution of programs are expanded and stored, is a volatile storage medium.

The encryption circuit 14 is to be used as a unit that adds a digital signature. In this embodiment, a usage of an RSA (Rivest Shamir Adleman) secret code is assumed and an algorithm for a hash function and a public key encryption is provided. Besides, a function of generating the private key and the public key is provided. While a public key cryptosystem by the RSA encryption is used for adding a digital signature in this embodiment, the present invention is not limited thereto and other key methods and encryption methods may be used.

The network I/F 15 is a transmission/reception terminal that performs a communication with the management server 6 and the like as an external device.

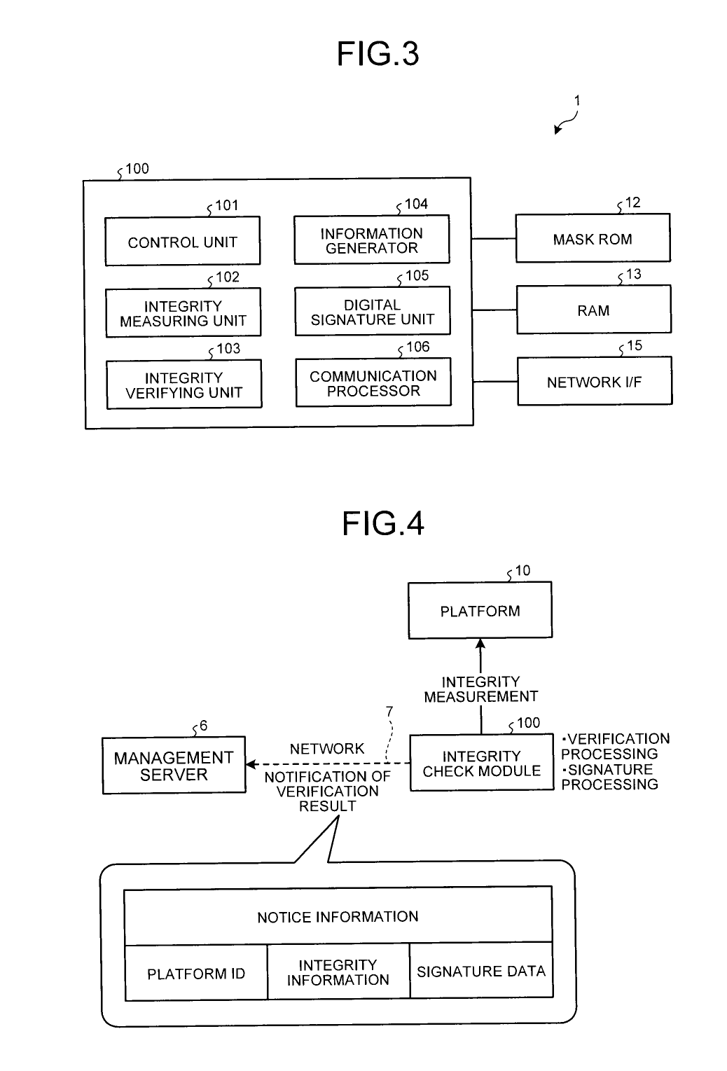

Next, a detail of the integrity check module 100 will be explained. FIG. 3 illustrates a software configuration of the integrity check module according to the first embodiment. As illustrated in FIG. 3, the integrity check module 100 is mainly provided with a control unit 101, an integrity measuring unit 102, an integrity verifying unit 103, an information generator 104, a digital signature unit 105, a communication processor 106, the mask ROM 12, the RAM 13, and the network I/F 15. Here, the mask ROM 12, the RAM 13, and the network I/F 15 will not be explained redundantly since being already explained.

The control unit 101, which controls an entirety of the integrity check module 100, calls each of the following units depending on each processing when called at the time of a start-up of the platform 10 and causes each of the called units to perform a processing.

The integrity measuring unit 102 measures a measurement value of the integrity of the platform 10 from the firmware information stored in the mask ROM 12 when the platform 10 is started. Specifically, the integrity measuring unit 102 reads out the firmware information stored in the mask ROM 12 and multiplies the read firmware information by the hash function to measure the integrity of the platform and calculate a measurement value.

The integrity verifying unit 103 compares the measurement value measured by the integrity measuring unit 102 with the expectation value stored in the mask ROM 12, and verifies the integrity of the platform 10 depending on whether or not the both values correspond to each other. In other words, when the measurement value and the expectation value correspond to each other, the integrity of the platform 10 is considered to be maintained and when the measurement value and the expectation value do not correspond to each other, the integrity of the platform 10 is considered to be impaired.

The information generator 104 generates integrity information indicating a result of the verification to the effect that the integrity of the platform 10 is impaired when the measurement value and the expectation value do not correspond to each other in the verification by the integrity verifying unit 103. Here, the information generator 104 does not generate integrity information when the integrity is maintained.

The digital signature unit 105 adds signature data (signature information) of the integrity information to the integrity information generated by the information generator 104. Specifically, the digital signature unit 105 obtains a hash value by multiplying the generated integrity information by the hash function, for example. The digital signature unit 105 then reads out the private key (first key information) stored in the mask ROM 12 and encrypts the hash value obtained from the integrity information with the read private key to generate signature data. The digital signature unit 105 then adds the generated signature data and a platform ID (identifier) specific to the platform 10 to the integrity information to generate notice information.

A data structure of the notice information will be explained here. FIG. 4 is an explanatory view of a data structure of the notice information according to the first embodiment. The notice information, which is to be transmitted from the integrity check module 100 of the electronic device 1 to the management server 6, includes the platform ID and the signature data in addition to the integrity information as illustrated in FIG. 4.

The communication processor 106 transmits the notice information including the signature data and the platform ID in addition to the integrity information to the management server 6.

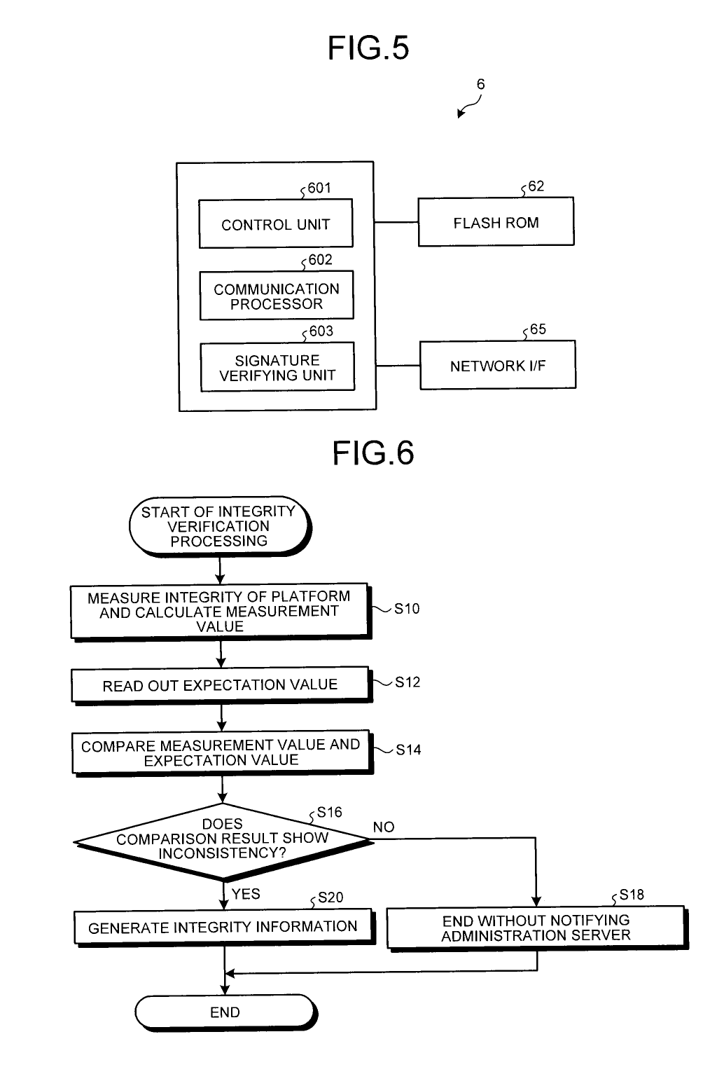

Next, a detail of the management server 6 will be explained. FIG. 5 illustrates a software configuration of the management server according to the first embodiment. As illustrated in FIG. 5, the management server 6 is mainly provided with a flash ROM 62, a network I/F 65, a control unit 601, a communication processor 602, and a signature verifying unit 603.

The flash ROM 62, which is a memory storing the integrity information, to be received from the electronic device 1, of the platform 10 of the electronic device 1, is a non-volatile storage medium. The flash ROM 62 stores the public key (second key information) with which the encrypted signature data is decrypted. The flash ROM 62 may be referred to as a second storage unit.

The network I/F 65 is a transmission/reception terminal that communicates with an external device such as the electronic device 1.

The control unit 601, which controls an entirety of the management server 6, calls each of the following units depending on each processing and causes each of the called units to perform a processing. The communication processor 602 receives the notice information including the signature data and the platform ID in addition to the integrity information from the electronic device 1.

The signature verifying unit 603 verifies validity of the integrity information based on the signature data which is added to the integrity information in the notice information received from the electronic device 1 and stores the received integrity information in the flash ROM 62 when the integrity information is valid. Specifically, the signature verifying unit 603 decrypts the encrypted signature data with the public key stored in the flash ROM 62 and calculates a hash value by multiplying the received integrity information by the hash function, for example. The signature verifying unit 603 then compares the decrypted signature data with the hash value of the integrity information and it is to be verified, when both correspond to each other, that the integrity information is valid without falsification of the data in the communication path.

Next, a processing until the integrity check module 100 verifies the integrity of the platform 10 and notifies the management server 6 of the verification result in response to the start-up, as a trigger, of the platform 10 will be explained with reference to FIGS. 6 to 8. FIG. 6 is a flowchart of an integrity verification processing of the platform in the integrity check module according to the first embodiment.

When the platform 10 is started, the integrity measuring unit 102 first measures the integrity of the platform 10 to calculate a measurement value (step S10). The integrity verifying unit 103 then reads out the expectation value from the mask ROM 12 (step S12) and compares the measurement value with the expectation value to verify the integrity (step S14).

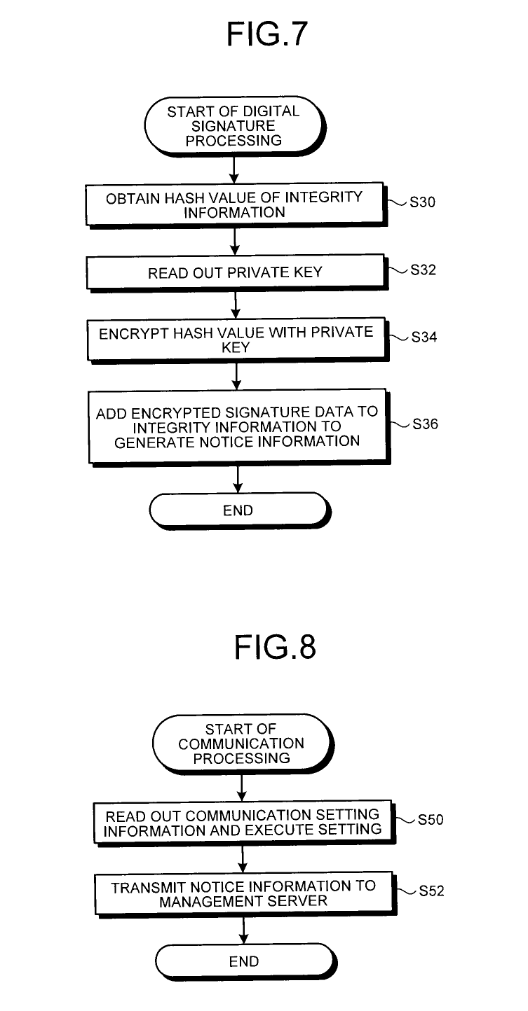

The integrity verifying unit 103 determines whether or not the result of the comparison shows inconsistency (step S16) and, when the result of the comparison does not show inconsistency (“No” at step S16), ends the processing without notifying the management server 6 (step S18). On the other hand, when the result of the comparison shows inconsistency (“Yes” at step S16), the information generator 104 generates integrity information indicating that the integrity is impaired (step S20) and the processing moves to a digital signature processing in FIG. 7.

FIG. 7 is a flowchart of a digital signature processing in the integrity check module according to the first embodiment. When the integrity information is generated by the information generator 104 (step S20 in FIG. 6), the digital signature unit 105 obtains a hash value by multiplying the integrity information by the hash function (step S30).

Next, the digital signature unit 105 reads out the private key from the mask ROM 12 (step S32) and encrypts the hash value obtained from the integrity information with the read private key (step S34). The digital signature unit 105 then adds the signature data obtained by encrypting the hash value to the integrity information and generates the notice information (step S36), and the processing moves to a communication processing in FIG. 8.

FIG. 8 is a flowchart of a communication processing in the integrity check module according to the first embodiment. When the notice information is generated by the digital signature unit 105 (step S36 in FIG. 7), the communication processor 106 reads out the communication setting information from the mask ROM 12 and executes the setting of the communication (step S50). The communication processor 106 then transmits the generated notice information to the management server 6 (step S52).

The management server 6 then verifies the validity of the integrity information based on the signature data in the received notice information and stores the received integrity information in the flash ROM 62 when the integrity information is valid. The management server 6 administers the integrity information of the electronic device 1 connected via the network 7 in this manner.

As explained, the integrity of the platform 10 of the electronic device 1 is verified in the electronic device 1, the integrity information indicating that the integrity is impaired when so is generated, the notice information including the signature data in addition to the integrity information is then generated, and the generated notice information is transmitted to the management server 6 in the information processing system according to the present embodiment. Since the validity of the integrity information can be determined by adding the signature data to the integrity information at the side of the management server 6, it is therefore possible to secure the reliability of the communication path along with the integrity information of the platform 10 of the electronic device 1 is transmitted to the management server 6. In addition, it is possible by performing the verification of the integrity of the platform 10 in the electronic device 1 to eliminate the necessity of retaining verification programs for a plurality of electronic devices connected to the network 7 in the management server 6 and thereby to reduce the management cost.

### Second Embodiment

In the information processing system according to the first embodiment, the signature data added to the integrity information in which the integrity of the platform of the electronic device is verified in the electronic device is transmitted to the management server. In contrast to this, an information processing device according to this embodiment is configured to update the platform of the electronic device, the expectation value, and the key information (private key and public key) in addition to the function according to the first embodiment.

The entire configuration of the information processing system is the same as that according to the first embodiment and the information processing system is configured by an electronic device 2 and the management server 6 (see FIG. 1).

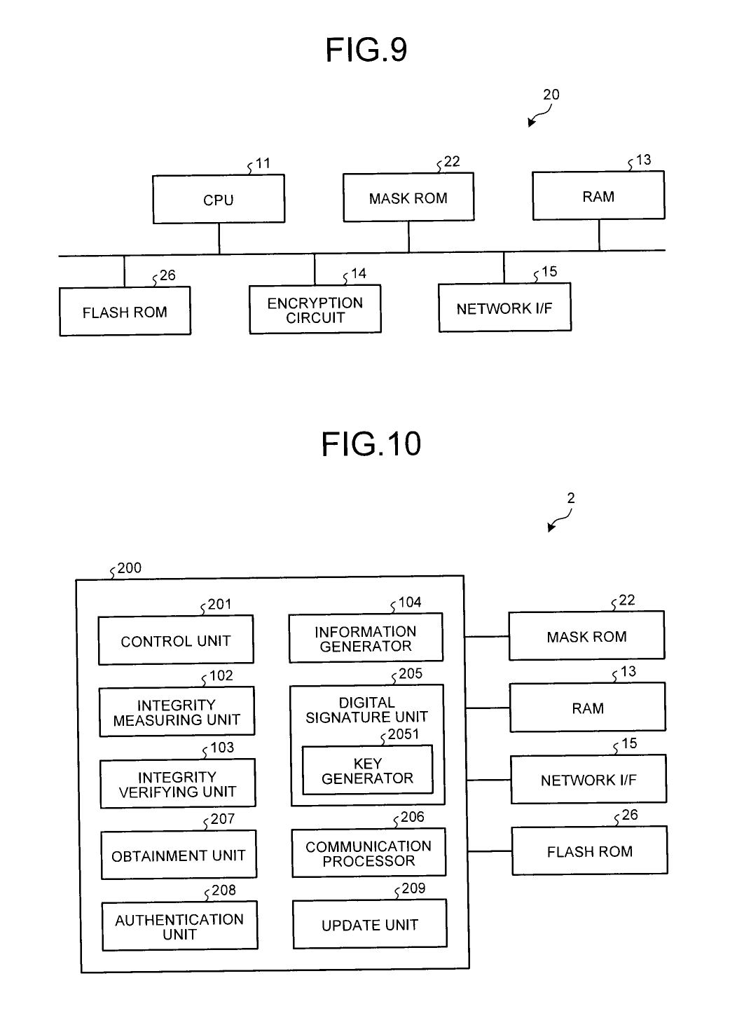

Next, a hardware configuration of a platform 20 will be explained. FIG. 9 illustrates a hardware configuration of the platform according to the second embodiment. As illustrated in FIG. 9, the platform 20 is mainly provided with the CPU 11, a mask ROM 22, the RAM 13, the encryption circuit 14, the network I/F 15, and a flash ROM 26. Here, the functions and configurations of the CPU 11, the RAM 13, the encryption circuit 14, and the network I/F 15 are the same as those in the first embodiment and therefore the explanation thereof will not be made redundantly.

The mask ROM 22, which is a memory in which various kinds of programs are stored, is a non-volatile storage medium in which an exogenous rewriting is disabled. Specifically, an integrity verification program to be executed in an integrity check module 100 is stored in the mask ROM 22. Besides, a digital signature execution program to add a digital signature and a program enabling a communication with an external device are stored in the mask ROM 22. In addition, a user ID who is allowed to update information in the electronic device 2 and a password (user list) are stored in the mask ROM 22. The mask ROM 22 may be referred to as a first storage unit.

The flash ROM 26, which is a memory in which various kinds of programs are stored, is a non-volatile storage medium capable of reading and writing. Specifically, firmware information (platform information) of the platform 20 of the electronic device 2 is stored in the flash ROM 26. Besides, an expectation value, which is a value used for verifying the integrity of the platform 20 and a preset measurement value expected for the measurement, is stored in the flash ROM 26. A private key (first key information), which is key information used for digital signature and with which signature data (signature information) is generated by encrypting the integrity information, and a public key (second key information), which corresponds to the private key and with which the encrypted signature data is decrypted are stored in the flash ROM 26. Besides, communication setting information set in performing a communication and communication destination information specifying a destination of the communication are stored in the flash ROM 26. Moreover, a hash function used for verifying the integrity of the platform 20 and in generating the signature data is stored in the flash ROM 26. The flash ROM 26 may also be referred to as the first storage unit.

Next, a detail of an integrity check module 200 will be explained. FIG. 10 illustrates a software configuration of the integrity check module according to the second embodiment. As illustrated in FIG. 10, the integrity check module 200 is mainly provided with a control unit 201, the integrity measuring unit 102, the integrity verifying unit 103, the information generator 104, a digital signature unit 205, a communication processor 206, an obtainment unit 207, an authentication unit 208, an update unit 209, the mask ROM 22, the RAM 13, the network I/F 15, and the flash ROM 26.

Here, the mask ROM 22, the RAM 13, the network I/F 15, and the flash ROM 26 will not be explained redundantly since being already explained. Besides, the integrity measuring unit 102, the integrity verifying unit 103, and the information generator 104 will not be explained redundantly since being the same as those in the first embodiment.

The control unit 201, which controls an entirety of the integrity check module 200, calls each of units depending on each processing when called at the time of a start-up of the platform 20 and causes each of the called units to perform a processing. Besides, the control unit 201 causes each of the following units to perform a processing of updating the firmware information and the key information when update information is obtained from a user or at intervals of a predetermined period of time.

The obtainment unit 207 obtains firmware update information for updating the platform 20, a new expectation value to be updated together with the update of the platform 20, and update information including a user ID (user identifying information) and a password identifying the user (person who performs updating).

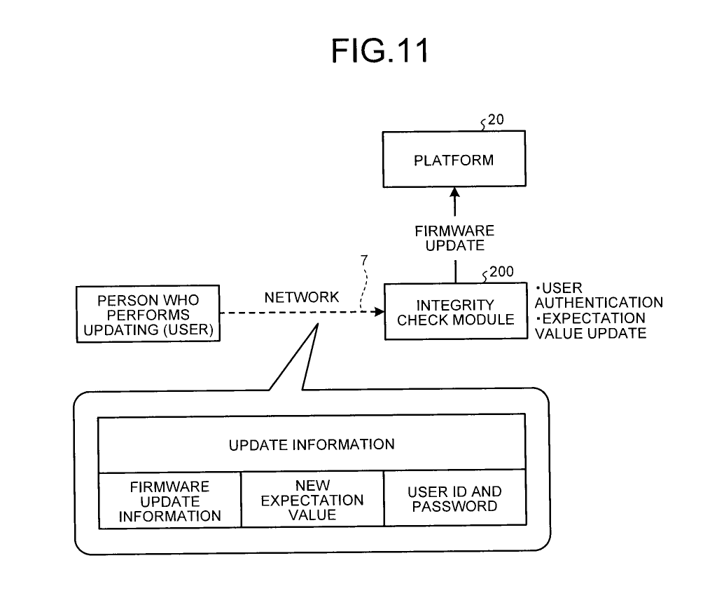

Here, a data structure of the update information will be explained. FIG. 11 is an explanatory view of a data structure of the update information according to the second embodiment. The update information, which is obtained from the user (person who performs updating) via the network 7, includes firmware update information, a new expectation value, and a user ID and a password as illustrated in FIG. 11. While the update information is obtained via the network 7 here, other methods may be adopted for the obtainment.

The authentication unit 208 authenticates users by the user ID and the password obtained by the obtainment unit 207. Specifically, the authentication unit 208 reads out the user list stored in the mask ROM 22 to compare the obtained user ID and password with user ID and password in the user list. The authentication unit 208 determines that the user authentication ends in success when both correspond to each other, and that the user authentication ends in failure when both do not correspond to each other. Here in the present embodiment, a valid user stored in the mask ROM 22 is assumed to be set in advance and not to be added or eliminated later.

When the user authentication ends in success, the update unit 209 updates the firmware information stored in the flash ROM 26 by the firmware update information included in the obtained update information and updates the expectation value stored in the flash ROM 26 by the new expectation value included in the obtained update information. When the user authentication ends in failure, the obtained update information is discarded.

The digital signature unit 205 is provided with a key generator 2051 in addition to the function in the first embodiment. The key generator 2051 may be referred to as a key information generator.

The key generator 2051 generates and stores in the flash ROM 26 the private key and the public key at intervals of a predetermined period of time to update the private key and the public key.

The digital signature unit 205 uses the private key stored in the flash ROM 26 to encrypt the newly-generated public key (new public key). Specifically, the digital signature unit 205 obtains a hash value by multiplying the new public key by the hash function, for example, reads out the private key stored in the flash ROM 26, and encrypts the new public key with the read private key.

The communication processor 206 transmits the new public key encrypted by the digital signature unit 205 to the management server 6. The management server 6 then uses the communication processor 602 (see FIG. 5) to receive the encrypted new public key and stores the received new public key in the writable mask ROM 62 to update the public key. Here, the management server 6 is assumed to store the initial public key in advance.

Next, the management server 6 will be explained. Since the management server 6 is the same as the first embodiment, a function to be added in the present embodiment will be explained below with reference to FIG. 5.

The communication processor 602 receives and stores in the flash ROM 62 the encrypted new public key in addition to the function in the first embodiment.

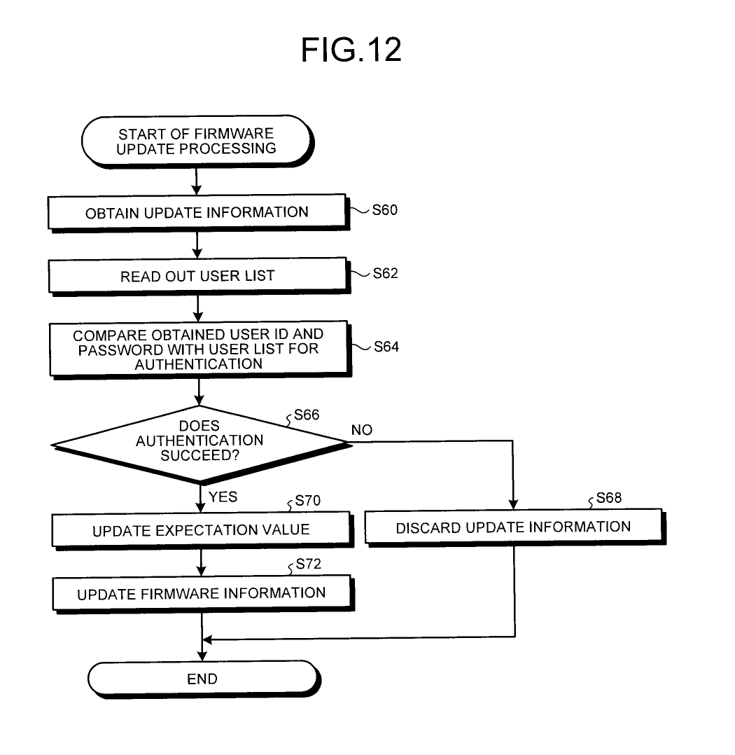

Next, a processing of updating the firmware information by the integrity check module 200 when the update information is obtained will be explained. FIG. 12 is a flowchart of a firmware update processing in the integrity check module according to the second embodiment.

When the obtainment unit 207 first obtains update information from the user (person who performs updating) (step S60), the authentication unit 208 reads out the user list from the mask ROM 22 (step S62) and compares the user ID and the password included in the obtained update information with the read user list to perform authentication (step S64).

The authentication unit 208 determines whether or not the authentication ends in success (step S66) and the update unit 209 discards the obtained update information (step S68) when the authentication ends in failure (“No” at step S66), i.e., when the result of the comparison shows inconsistency and ends the processing.

On the other hand, when the authentication ends in success (“Yes” at step S66), i.e., when the result of the comparison shows consistency, the update unit 209 updates the expectation value in the flash ROM 26 (step S70), updates the firmware information (step S72), and ends the processing.

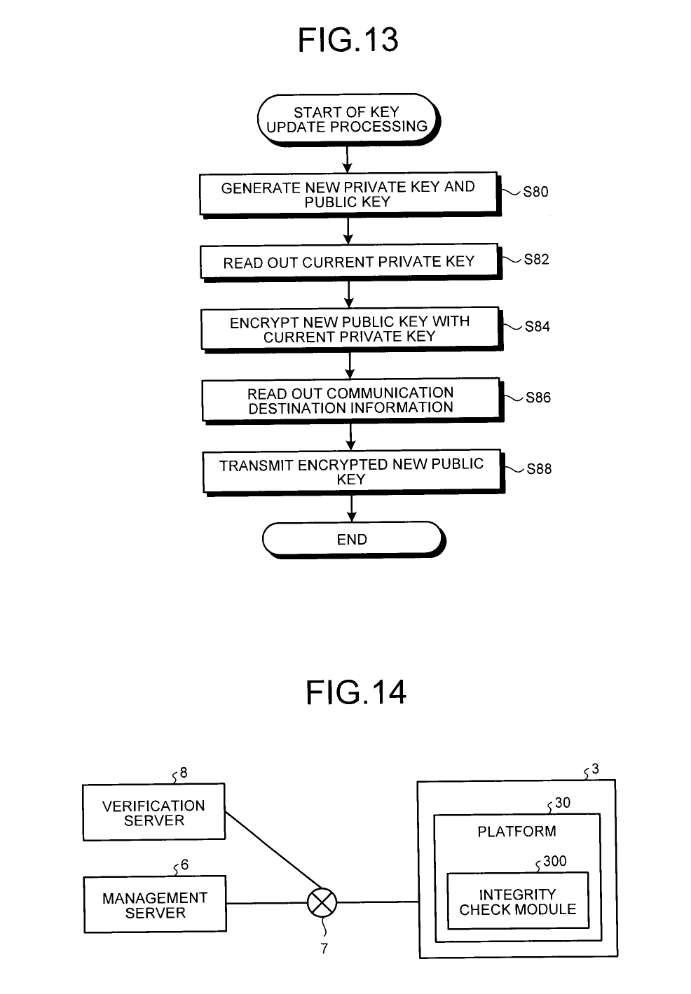

Next, a processing of updating the private key and the public key in the integrity check module 200 will be explained. FIG. 13 is a flowchart of a key update processing in the integrity check module according to the second embodiment.

When the predetermined period of time elapses, the key generator 2051 first generates a new private key and public key (step S80). The digital signature unit 205 then obtains the current private key stored in the flash ROM 26 (step S82) and encrypts the generated new public key with the current private key (step S84).

The communication processor 206 next reads out communication destination information from the flash ROM 26 (step S86), transmits the encrypted new public key to the management server 6 which is the destination of the communication (step S88), and ends the processing.

The communication processor 602 of the management server 6 then receives and stores in the flash ROM 62 the encrypted new public key.

While the configuration of using the public key cryptosystem is taken as an example in the explanation in the present embodiment, any configuration using other systems may be adopted as far as a communication security is secured.

In this manner, the firmware information of the platform 20 of the electronic device 2, the expectation value, and the key information are updated in the information processing system according to the present embodiment in addition to the configuration in the first embodiment. As explained so far, it is possible by authenticating a user (person who performs updating) to prevent an update of the expectation value by an invalid user in updating the expectation value associated with the update of the firmware information of the platform 20. Besides, it is possible by updating the private key for the purpose of maintaining the reliability of the communication path and transmitting the encrypted new public key to the management server 6 to safely give notice of the public key.

### Third Embodiment

In the information processing system according to the first embodiment, the signature data added to the integrity information in which the integrity of the platform of the electronic device is verified in the electronic device is transmitted to the management server. In contrast to this, a verification server connected via the network is configured to verify and transmit to the management server the integrity of the platform of the electronic device in an information processing device according to the present embodiment.

FIG. 14 illustrates an entire configuration of an information processing system according to the third embodiment. As illustrated in FIG. 14, the information processing system according to the present embodiment is configured by an electronic device 3, the management server (management device) 6, and a verification server (verification device) 8. The electronic device 3, the management server 6, and the verification server 8 are connected by the network 7. An integrity check module 300 is provided in a platform 30 of the electronic device 3, and the platform 30 and the integrity check module 300 are configured as one chip. Since the hardware configuration of the platform 30 is the same as that according to the first embodiment, the explanation thereof will not be made redundantly.

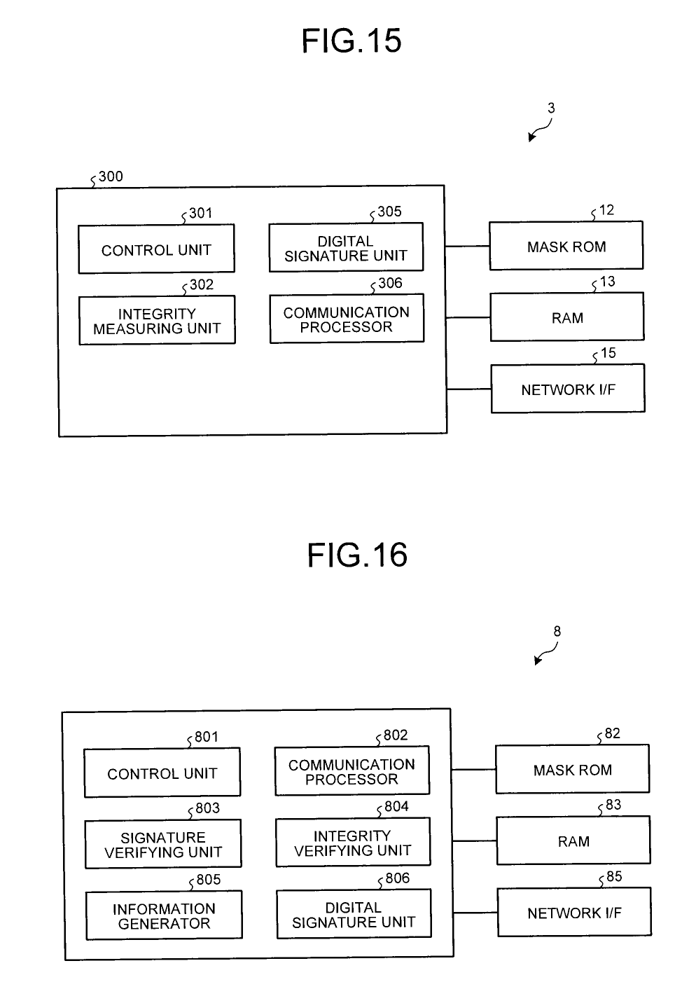

Next, a detail of the integrity check module 300 will be explained. FIG. 15 illustrates a software configuration of the integrity check module according to the third embodiment. As illustrated in FIG. 15, the integrity check module 100 is mainly provided with a control unit 301, an integrity measuring unit 302, a digital signature unit 305, a communication processor 306, the mask ROM 12, the RAM 13, and the network I/F 15. Here, the mask ROM 12, the RAM 13, and the network I/F 15 are the same as those in the first embodiment. The mask ROM 12 may not retain the integrity verification program.

The control unit 301, which controls an entirety of the integrity check module 300, calls each of the following units depending on each processing when called at the time of a start-up of the platform 30 and causes each of the called units to perform a processing.

The integrity measuring unit 302 measures a measurement value of the integrity of the platform 30 from the firmware information stored in the mask ROM 12 when the communication processor 306 receives an integrity measurement request by which a measurement value of the integrity of the platform 30 is requested. Specifically, the integrity measuring unit 302 reads out the firmware information stored in the mask ROM 12 and multiplies the read firmware information by the hash function to measure the integrity of the platform 30 and calculate a measurement value.

The digital signature unit 305 adds signature data (first signature information) of a measurement value to the measurement value of the integrity measured by the integrity measuring unit 302. Specifically, the digital signature unit 305 obtains a hash value by multiplying the measured measurement value by the hash function, for example. The digital signature unit 305 then reads out the private key (first key information) stored in the mask ROM 12 and encrypts the hash value obtained from the measurement value with the read private key to generate signature data. The digital signature unit 305 then adds the generated signature data to the measurement value.

The communication processor 306 receives the integrity measurement request of requesting the measurement value of the integrity of the platform 30 from the verification server 8. Besides, the communication processor 306 transmits the measurement value of the integrity (measurement result) to which the signature data is added by the digital signature unit 305 to the verification server 8. The communication processor 306 may be referred to as a first communication processor.

Next, a detail of the verification server 8 will be explained. FIG. 16 illustrates a software configuration of the verification server according to the third embodiment. As illustrated in FIG. 16, the verification server 8 is mainly provided with a control unit 801, a communication processor 802, a signature verifying unit 803, an integrity verifying unit 804, an information generator 805, a digital signature unit 806, a mask ROM 82, a RAM 83, and a network I/F 85.

The mask ROM 82, which is a memory in which various kinds of programs are stored, is a non-volatile storage medium. Specifically, an integrity verification program that enables a verification of the integrity of the platform 30 in the electronic device 3, a digital signature execution program that enables adding a digital signature, and a program that enables a communication with an external device are stored in the mask ROM 82.

Besides, an expectation value, which is a value used for verifying the integrity of the platform 30 and a preset measurement value expected for the measurement, is stored in the mask ROM 82. A private key, which is key information used for digital signature and with which signature data (signature information) is generated by encrypting integrity information and a public key, which corresponds to the private key and with which the encrypted signature data is decrypted are stored in the mask ROM 82. Communication setting information set in performing a communication is also stored in the mask ROM 82. Besides, a hash function used in verifying the integrity of the platform 30 and in generating the signature data is stored in the mask ROM 82. The mask ROM 82 may be referred to as a second storage unit.

The RAM 83, which is a memory in which various kinds of programs and variables during the execution of programs are expanded and stored, is a volatile storage medium. The network I/F 85 is a transmission/reception terminal that performs a communication with the electronic device 3, the management server 6, and the like each as an external device.

The control unit 801, which controls an entirety of the verification server 8, calls each of the following units depending on each processing and causes each of the called units to perform a processing.

The communication processor 802 transmits an integrity measurement request of requesting a measurement value of the integrity of the platform 30 to the electronic device 3 when receiving an integrity verification request of the platform 30 of the electronic device 3 from the management server 6. The communication processor 802 then receives the measurement value (measurement result) to which the signature data is added, of the integrity of the platform 30 of the electronic device 3 from the electronic device 3. The communication processor 802 transmits notice information (verification result) including the signature data in addition to the integrity information by the digital signature unit 806 to the management server 6. The communication processor 802 may be referred to as a second communication processor.

The signature verifying unit 803 verifies the validity of the measurement value based on the signature data added to the received measurement value. Specifically, the signature verifying unit 803 decrypts the encrypted signature data with the public key stored in the mask ROM 82 and calculates a hash value by multiplying the received measurement value by the hash function, for example. The signature verifying unit 803 then compares the decrypted signature data with the hash value of the measurement value and it is to be verified, when both correspond to each other, that the measurement value is valid without falsification of the data in the communication path. The signature verifying unit 803 may be referred to as a first signature verifying unit.

The integrity verifying unit 804 compares the received measurement value with the expectation value stored in the mask ROM 82 when the measurement value is verified to be valid and verify the integrity of the platform 30 of the electronic device 3 depending on whether or not the both values correspond to each other. In other words, when the measurement value and the expectation value correspond to each other, the integrity of the platform 30 is considered to be maintained and when the measurement value and the expectation value do not correspond to each other, the integrity of the platform 30 is considered to be impaired.

The information generator 805 generates integrity information indicating a result of the verification to the effect that the integrity of the platform 30 is impaired when the measurement value and the expectation value do not correspond to each other in the verification by the integrity verifying unit 804.

The digital signature unit 806 adds signature data (second signature information) of the integrity information to the integrity information generated by the information generator 805. Specifically, the digital signature unit 806 obtains a hash value by multiplying the generated integrity information by the hash function, for example. The digital signature unit 806 then reads out the private key stored in the mask ROM 82 and encrypts the hash value obtained from the integrity information with the read private key to generate signature data. The digital signature unit 806 then adds the generated signature data to the integrity information to generate notice information. The digital signature unit 806 may be referred to as a second signature unit.

Since the configuration of the management server 6 is the same as that according to the first embodiment, the explanation thereof will not be made redundantly (see FIG. 5). The management server 6 according to the present embodiment transmits the request of verifying the integrity of the platform 30 of the electronic device 3 to the verification server 8 and receives the notice information including the integrity information not from the electronic device 3 but from the verification server 8. The flash ROM 62 of the management server 6 may be referred to as a third storage unit and the signature verifying unit 603 may be referred to as a second signature verifying unit.

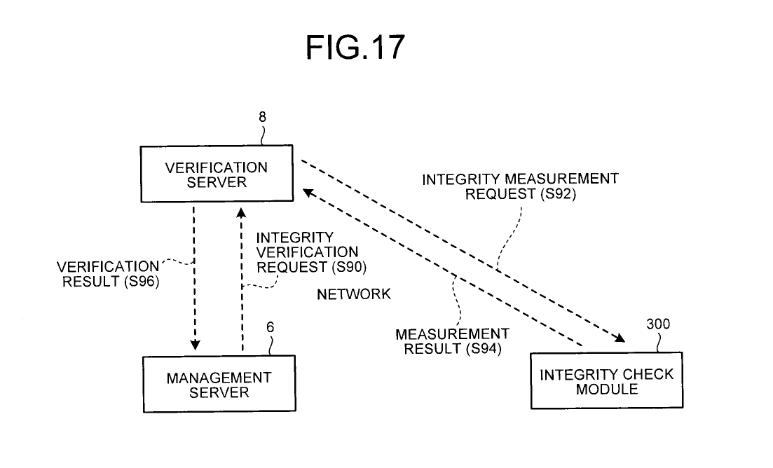

Next, a flow of verifying the integrity of the platform 30 of the electronic device 3 in the information processing system will be explained. FIG. 17 illustrates a flow of an integrity verification processing of the platform of the electronic device in the information processing system according to the third embodiment.

As illustrated in FIG. 17, the management server 6 transmits an “integrity verification request” of requesting a verification of the integrity of the platform 30 of the electronic device 3 to the verification server 8 (step S90). When receiving the “integrity verification request”, the verification server 8 transmits a “integrity measurement request” of requesting a measurement of the integrity of the platform to the integrity check module 300 of the electronic device 3 (step S92).

When receiving the “integrity measurement request”, the integrity check module 300 measures the integrity of the platform 30 of the electronic device 3 and transmits the measurement value of the integrity as a “measurement result” to the verification server 8 (step S94). When receiving the “measurement result”, the verification server 8 verifies the integrity of the platform 30 of the electronic device 3 and transmits a “verification result” (notice information) to the management server 6 (step S96).

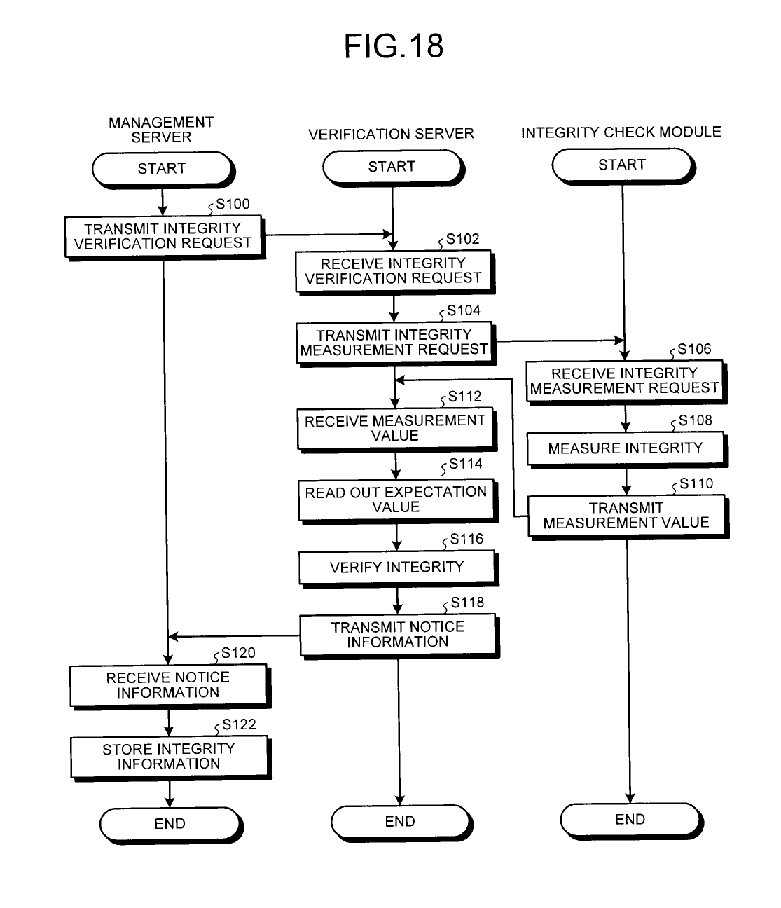

Next, a processing of verifying the integrity of the platform 30 of the electronic device 3 in the information processing system according to the present embodiment will be explained. FIG. 18 is a flowchart of the integrity verification processing of a platform in the information processing system according to the third embodiment.

When the management server 6 transmits the request of verifying the integrity of the platform 30 of the electronic device 3 to the verification server 8 (step S100), the communication processor 802 of the verification server 8 receives the integrity verification request (step S102).

Next, when the communication processor 802 of the verification server 8 transmits the integrity measurement request to the integrity check module 300 for the purpose of the integrity verification usage (step S104), the communication processor 306 of the integrity check module 300 in the electronic device 3 receives the integrity measurement request (step S106).

Next, the integrity check module 300 uses the integrity measuring unit 302 to measure the integrity of the platform 30 (step 5108) and uses the digital signature unit 305 to add signature data to the measurement value. The communication processor 306 of the integrity check module 300 transmits the measurement value of the integrity to which the signature data is added to the verification server 8 (step S110).

Next, when the verification server 8 uses the communication processor 802 to receive the measurement value to which the signature data is added, of the integrity (step S112). When the signature verifying unit 803 verifies the validity of the measurement value and the value is valid, the integrity verifying unit 804 reads out the expectation value from the mask ROM 82 (step S114).

The integrity verifying unit 804 then verifies the integrity of the platform 30 based on the received measurement value and the read expectation value (step S116), and the information generator 805 generates integrity information to the effect that the integrity of the platform 30 is impaired and the digital signature unit 806 generates notice information including the signature data in addition to the integrity information when the measurement value and the expectation value do not correspond to each other.

The communication processor 802 of the verification server 8 transmits the generated notice information to the management server 6 (step S118). When receiving the notice information (step S120), the communication processor 602 of the management server 6 stores the integrity information in the mask ROM 82 when the integrity information is valid in the verification by the signature verifying unit 603 (step S122).

In this manner, the integrity of the platform 30 is measured in the electronic device 3 and the signature data is added to the measured measurement value and transmitted to the verification server 8 in the information processing system according to the present embodiment. The integrity of the platform 30 of the electronic device 3 is then verified in the verification server 8 based on the transmitted measurement value, integrity information to the effect that the integrity is impaired if so is generated, notice information including the signature data in addition to the integrity information is further generated, and the generated notice information is transmitted to the management server 6. Since the validity of the measurement value can be judged at the side of the verification server 8 by adding the signature data to the measurement value, it is possible to secure the reliability of the communication path along which the measurement value is transmitted to the verification server 8. Besides, since the validity of the integrity information can be judged at the side of the management server 6 by adding the signature data to the integrity information, it is possible to secure the reliability of the communication path along which the integrity information of the platform 30 of the electronic device 3 is transmitted to the management server 6. Moreover, it becomes unnecessary by verifying the integrity of the platform 30 in the verification server 8 to retain a verification program for a plurality of electronic devices 3 connected to the network 7 in the management server 6, which thereby results in reduction in management cost.

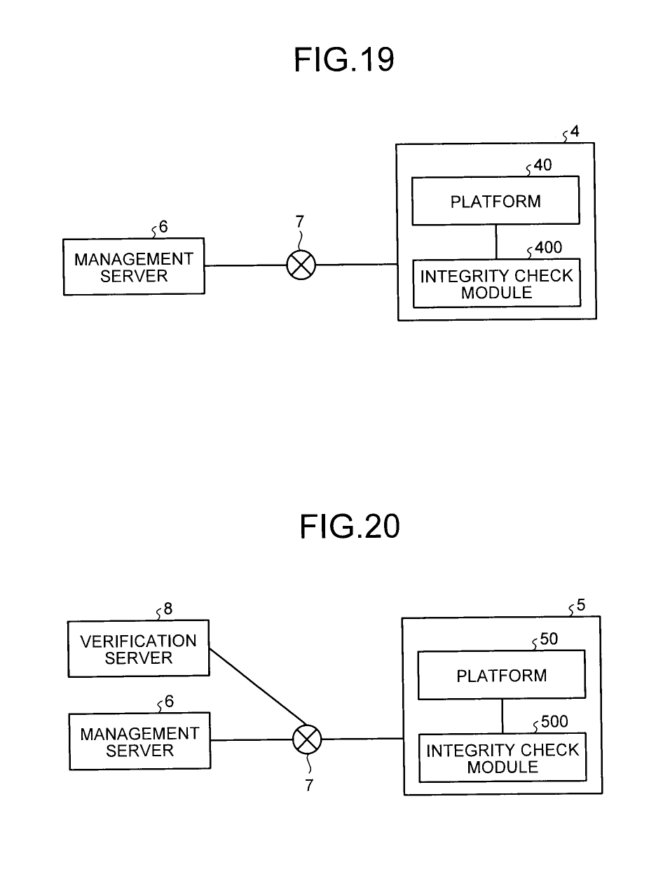

Here as a modification example of the first embodiment, a platform 40 of an electronic device 4 and an integrity check module 400 may be configured as separated chips and configured to be connected by an external interface as illustrated in FIG. 19.

Moreover as a modification example of the third embodiment, a platform 50 of an electronic device 5 and an integrity check module 500 may be configured as separated chips and configured to be connected by an external interface.

While the hash value is used to measure the integrity of the platform in the information processing systems according to the first to the third embodiments, the measurement of the integrity may be performed by signature. When the integrity check module has a plurality of measurement targets, it is possible to reduce a storage area to be used for the integrity verification program and the like and thereby reduce cost. Moreover, it becomes unnecessary to update the expectation value associated with the update of the firmware information.

In the information processing systems according to the first to the third embodiments, the storage (mask ROM and flash ROM) may be configured to be encrypted. It thereby becomes possible to eliminate a possibility that the private key and information regarding user authentication (user ID and the like) should be obtained by an unauthorized third party.

The information processing program to be executed in the electronic devices according to the first to the third embodiments is provided by being recorded in a file of an installable format or of an executable format in a computer-readable storage medium such as a CD-ROM, a flexible disk (FD), a CD-R, and a DVD (Digital Versatile Disk).

The information processing program to be executed in the electronic devices according to the first to the third embodiments may be provided by being stored on a computer connected to a network such as the Internet and downloaded via the network. The information processing program to be executed in the electronic devices according to the first to the third embodiments may be provided or distributed via a network such as the Internet.

The information processing program to be executed in the electronic devices according to the first to the third embodiments may be provided by being preloaded in a ROM and the like.

The information processing program to be executed in the electronic devices according to the first to the third embodiments has a module configuration including the above-described components and, as an actual hardware, a CPU (processor) reads out from the storage medium and executes the information processing program, so that each component is loaded and generated on the main storage device. Besides, a part or all of the functions of the above-described components may be realized by a dedicated hardware circuit.

According to the embodiment, there is an advantage in that a management cost is reduced while securing a reliability of a communication path along which integrity information of a platform of an electronic device is transmitted.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system, comprising:
a management device; and
an electronic device connected to the management device via a network, wherein
the electronic device includes
a first storage unit configured to store platform information regarding a platform of the electronic device and an expectation value that is preset and used for verifying an integrity of the platform;
a measuring unit configured to measure a measurement value of the integrity of the platform from the platform information stored in the first storage unit;
an integrity verifying unit configured to compare the measurement value and the expectation value stored in the first storage unit to verify the integrity of the platform depending on whether or not the measurement value is equal to the expectation value;
an information generating unit configured to generate integrity information indicating a verification result to an effect that the integrity of the platform is impaired when the measurement value is not equal to the expectation value;
a signature unit configured to add signature information of the integrity information to the generated integrity information; and
a communication processor configured to transmit the integrity information having the signature information to the management device, and
the management device includes
a second storage unit configured to store the integrity information;
a receiver configured to receive the integrity information from the electronic device; and
a signature verifying unit configured to verify a validity of the integrity information based on the signature information that is added to the received integrity information and store the received integrity information in the second storage unit when the integrity information is valid.

2. The information processing system according to claim 1, further comprising:
an obtainment unit configured to obtain platform update information used for updating the platform, a new expectation value to be updated together with the updating of the platform, and user identifying information for identifying a user;
an authentication unit configured to authenticates a user based on the obtained user identifying information; and
an update unit configured to, when the authentication of the user is successful, update the platform with the platform update information, store the new expectation value in the first storage unit, and update the expectation value.

3. The information processing system according to claim 1, wherein
the first storage unit further stores first key information used for encrypting the integrity information to generate the signature information, and second key information used for decrypting the signature information,
the signature unit encrypts the integrity information with the first key information to generate the signature information,
the second storage unit further stores the second key information,
the signature verifying unit decrypts the signature information with the second key information and verifies the validity of the integrity information,
the electronic device further includes a key information generator configured to generate the first key information and the second key information,
the signature unit encrypts the generated new second key information with the first key information stored in the first storage unit,
the communication processor transmits the encrypted new second key information to the management device, and
the receiver receives and stores in the second storage unit the encrypted new second key information.

4. The information processing system according to claim 3, wherein the key information generator generates the first key information and the second key information at every predetermined time interval.

5. The information processing system according to claim 1, wherein the measuring unit measures the measurement value when the platform is started.

6. The information processing system according to claim 1, wherein the measuring unit measures the measurement value by multiplying the platform information stored in the first storage unit by a hash function.

7. An information processing system, comprising:
a management device;
a verification device connected to the management device via a network; and
an electronic device connected to the verification device via the network, wherein
the electronic device includes
a first storage unit configured to store platform information regarding a platform of the electronic device;
a measuring unit configured to measure a measurement value of an integrity of the platform from the platform information stored in the first storage unit;
a first signature unit configured to add first signature information for the measurement value to the measurement value; and
a first communication processor configured to transmit the measurement value having the first signature information to the verification device,
the verification device includes
a second storage unit configured to store an expectation value that is preset and used for verifying the integrity of the platform of the electronic device;
a second communication processor configured to receive the measurement value from the electronic device;
a first signature verifying unit configured to verify a validity of the measurement value based on the first signature information that is added to the received measurement value;
an integrity verifying unit configured to compare the received measurement value and the expectation value stored in the second storage unit to verify the integrity of the platform depending on whether or not the measurement value is equal to the expectation value when the measurement value is verified to be valid;
an information generator configured to generate integrity information indicating a verification result indicating that the integrity of the platform is impaired when the measurement value is not equal to the expectation value; and
a second signature unit configured to add second signature information of the integrity information to the generated integrity information, wherein
the second communication processor transmits the integrity information having the second signature information to the management device, and
the management device includes
a third storage unit configured to store the integrity information;
a receiver configured to receive the integrity information from the verification device; and
a second signature verifying unit configured to verify a validity of the integrity information based on the second signature information that is added to the received integrity information, and store the received integrity information in the third storage unit when the integrity information is valid.

8. An electronic device connected to a management device via a network, comprising:
a storage unit configured to store platform information regarding a platform of the electronic device and an expectation value that is preset and used for verifying an integrity of the platform;
a measuring unit configured to measure a measurement value of the integrity of the platform from the platform information stored in the storage unit;
an integrity verifying unit configured to compare the measurement value and the expectation value stored in the storage unit to verify the integrity of the platform depending on whether or not the measurement value is equal to the expectation value;
an information generator configured to generate integrity information indicating a verification result indicating that the integrity of the platform is impaired when the measurement value is not equal to the expectation value;
a signature unit configured to add signature information of the integrity information to the generated integrity information; and
a communication processor configured to transmit the integrity information having the signature information to the management device.
